(19) United States
(12) Patent Application Publication
(10) Pub. No.: US 2007/0216965 A1
(43) Pub. Date: Sep. 20, 2007

(54) IMAGE PROCESSING APPARATUS, CUSTOMIZING METHOD OF USER INTERFACE SCREEN, AND COMPUTER-READABLE RECORDING MEDIUM STORING PROGRAM FOR EXECUTING THE METHOD

(76) Inventor: Maki YOSHIHAMA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,091

(22) Filed: Mar. 16, 2007

(30) Foreign Application Priority Data
Mar. 17, 2006 (JP) 2006-075642

(51) Int. Cl. H04N 1/04

(52) U.S. Cl. 358/474

(57) ABSTRACT

An image processing apparatus capable of displaying a user interface screen (UI screen) is disclosed. The image processing apparatus includes an input/output controlling unit to which customization information for customizing the UI screen is input by a user when the user inputs a customization request of the UI screen; and a UI screen generating unit which generates a new UI screen based on the customization information.

### BACKGROUND OF THE INVENTION

1. Field of the Invention

The present invention generally relates to an image processing apparatus which can display a user interface screen, a customizing method of the user interface screen, and a computer-readable recording medium storing a program for executing the method.

2. Description of the Related Art

Recently, an image processing apparatus such as a copier, a scanner, and an MFP (multifunctional peripheral) has provided an operating panel including a ten-key and a touch screen. That is, a user interface screen has been provided in the image processing apparatus. User operability can be increased by changing a user interface screen to another user interface screen which is requested by the user.

Operations of a user have been complex corresponding to multiple functions of the image processing apparatus. That is, the number of content items (for example, the number of buttons and the number of letters) which are displayed on the user interface screen has been increased; consequently, the operability has been decreased. Patent Document 1 discloses an image forming apparatus. In the image forming apparatus, colors and shapes of buttons and letters which are displayed on the user interface screen can be changed. With this, the operability of the user is increased.

[Patent Document 1] Japanese Laid-Open Patent Application No. 9-114627

However, even if a user rarely uses a function, the function is displayed on the user interface screen. Consequently, the operability is decreased.

In Patent Document 1, even if the colors and the shapes of the buttons and the letters are changed, the buttons and the letters are displayed on the user interface screen. That is, the congestion on the user interface screen is not solved. Consequently, the operability is not absolutely increased.

In addition, in a conventional image processing apparatus, the user interface screen is customized only by an exclusive tool. Therefore, the user interface screen cannot be customized into a user interface screen which a user can easily use.

### SUMMARY OF THE INVENTION

In a preferred embodiment of the present invention, there is provided an image processing apparatus which can easily customize a user interface screen, a customizing method of the user interface screen, and a computer-readable recording medium storing a program for executing the method.

Features and advantages of the present invention are set forth in the description that follows, and in part will become apparent from the description and the accompanying drawings, or may be learned by practice of the invention according to the teachings provided in the description. Features and advantages of the present invention will be realized and attained by an image processing apparatus, a customizing method of a user interface screen, and a computer-readable recording medium storing a program for executing the method particularly pointed out in this specification in such full, clear, concise, and exact terms as to enable a person having ordinary skill in the art to practice the invention.

To achieve one or more of these and other advantages, according to one aspect of the present invention, there is provided an image processing apparatus capable of displaying a user interface screen (UI screen). The image processing apparatus includes an input/output controlling unit to which customization information for customizing the UI screen is input by a user when the user inputs a customization request of the UI screen, and a UI screen generating unit which generates a new UI screen based on the customization information.

### EFFECT OF THE INVENTION

According to an embodiment of the present invention, an image processing apparatus capable of displaying a user interface screen, a customizing method of the user interface screen, and a computer-readable recording medium storing a program for executing the method can be realized, in which the user interface screen is easily customized.

### BRIEF DESCRIPTION OF THE DRAWINGS

Features and advantages of the present invention will become more apparent from the following detailed description when read in conjunction with the accompanying drawings, in which:

FIG. 1 is a block diagram showing a system including an MFP (multifunctional peripheral) according to embodiments of the present invention;

FIG. 2 is a block diagram showing an MFP according to a first embodiment of the present invention;

FIG. 3 is a sequence chart showing user interface screen (UI screen) customizing processes in the MFP according to the first embodiment of the present invention;

FIG. 4 is a first diagram showing UI screens which are displayed on an operating panel according to the first embodiment of the present invention;

FIG. 5 is a second diagram showing UI screens which are displayed on the operating panel according to the first embodiment of the present invention;

FIG. 6 is a block diagram showing an MFP according to a second embodiment of the present invention;

FIG. 7 is a sequence chart showing UI screen customizing processes in the MFP according to the second embodiment of the present invention;

FIG. 8 is a first diagram showing UI screens which are displayed on the operating panel according to the second embodiment of the present invention;

FIG. 9 is a second diagram showing UI screens which are displayed on the operating panel according to the second embodiment of the present invention;

FIG. 10 is a block diagram showing an MFP according to a third embodiment of the present invention;

FIG. 11 is a sequence chart showing UI screen customizing processes in the MFP according to the third embodiment of the present invention;

FIG. 12 is a first diagram showing UI screens which are displayed on the operating panel according to the third embodiment of the present invention;

FIG. 13 is a second diagram showing UI screens which are displayed on the operating panel according to the third embodiment of the present invention;

FIG. 14 is a diagram showing information to generate a new UI screen from a UI screen by customization;

FIG. 15 is a block diagram showing an MFP according to a fourth embodiment of the present invention;

FIG. 16 is a sequence chart showing UI screen customizing processes in the MFP according to the fourth embodiment of the present invention;

FIG. 17 is a first diagram showing UI screens which are displayed on the operating panel according to the fourth embodiment of the present invention;

FIG. 18 is a second diagram showing UI screens which are displayed on the operating panel according to the fourth embodiment of the present invention; and

FIG. 19 is a third diagram showing UI screens which are displayed on the operating panel according to the fourth embodiment of the present invention.

### DESCRIPTION OF THE PREFERRED EMBODIMENTS

### Best Mode of Carrying Out the Invention

The best mode of carrying out the present invention is described with reference to the accompanying drawings. In embodiments of the present invention, as the image processing apparatus, an MFP is used. However, the image processing apparatus is not limited to the MFP; when an image processing apparatus can display a user interface screen, that image processing apparatus can be used.

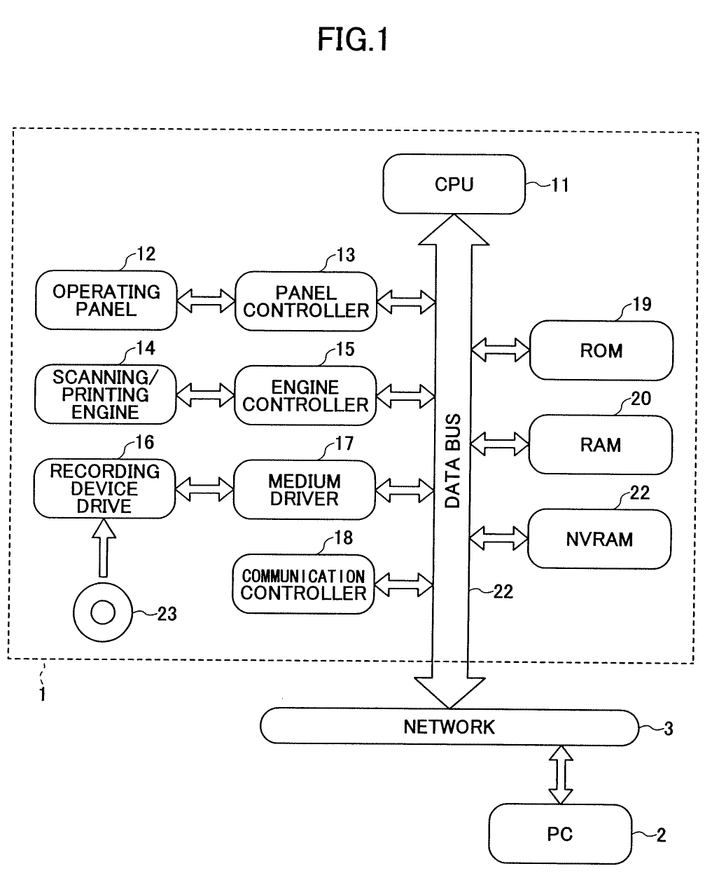

FIG. 1 is a block diagram showing a system including an MFP according to the embodiments of the present invention. As shown in FIG. 1, in the system, an MFP 1 and a PC (personal computer) 2 are connected via a network 3. The MFP 1 includes a CPU 11, an operating panel 12, a panel controller 13, a scanning/printing engine 14, an engine controller 15, a recording device drive 16, a medium driver 17, a communication controller 18, a ROM 19, a RAM 20, a NVRAM 21, and a data bus 22.

The operating panel 12 and the panel controller 13 operate as a user interface. The scanning/printing engine 14 and the engine controller 15 read data in a paper document and print the read data on a sheet as an input/output unit for image data.

The recording device drive 16 and the medium driver 17 store a large amount of image data and database data. The communication controller 18 communicates with the PC 2 via the network 3 such as an Ethernet LAN.

The ROM 19 stores program codes, font data, and other static data. The RAM 20 temporarily stores data being processed and to be processed. The NVRAM 21 provides non-volatile data storage. By the data bus 22, communications among devices (the panel controller 13, the engine controller 15, the medium driver 17, the communication controller 18, the ROM 19, the RAM 20, and the NVRAM 21) can be established. In addition, by the data bus 22, communications between the CPU 11 and the devices can be established.

In the embodiments of the present invention, a user interface screen customizing program is a part of programs for controlling the MFP 1. The user interface screen customizing program is stored in, for example, the ROM 19, the recording device drive 16 (for example, a HDD (hard disk drive)), or a recording medium 23 which is loaded in the recording device drive 16.

The recording medium 23 is, for example, a CR-ROM, a flexible disk, or an MO (magneto-optical disk), which records information optically, electrically, or magnetically; or a semiconductor memory such as a ROM, or a flash memory which records information electrically.

When a user requests to customize a user interface screen (hereinafter referred to as a UI screen), the RAM 20 loads the UI customizing program by reading from, for example, the recording medium 23. The CPU 11 establishes a program module (described below) based on the UI customizing program being loaded in the RAM 20.

### First Embodiment

First, a first embodiment of the present invention is described.

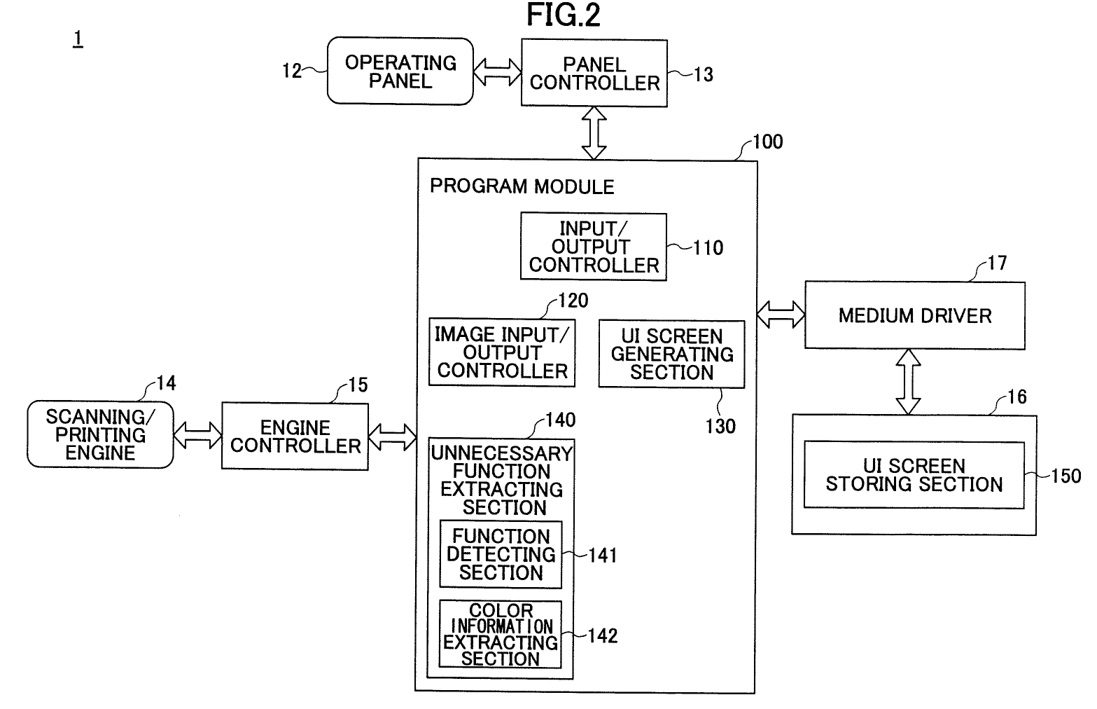

In the first embodiment of the present invention, a UI screen is customized by using a “x” mark. FIG. 2 is a block diagram showing the MFP 1 according to a first embodiment of the present invention. In the MFP 1 of the present embodiment, a program module 100 is established by a UI screen customizing program.

As shown in FIG. 2, the program module 100 includes an input/output controller 110, an image input/output controller 120, a UI screen generating section 130, and an unnecessary function extracting section 140. The unnecessary function extracting section 140 includes a function detecting section 141 and a color information extracting section 142. In addition, as shown in FIG. 2, the MFP 1 further includes a UI image storing section 150. The UI image storing section 150 stores image data to print a UI (user interface) image. In the MFP 1 shown in FIG. 2, only main elements for generating the UI screen are shown.

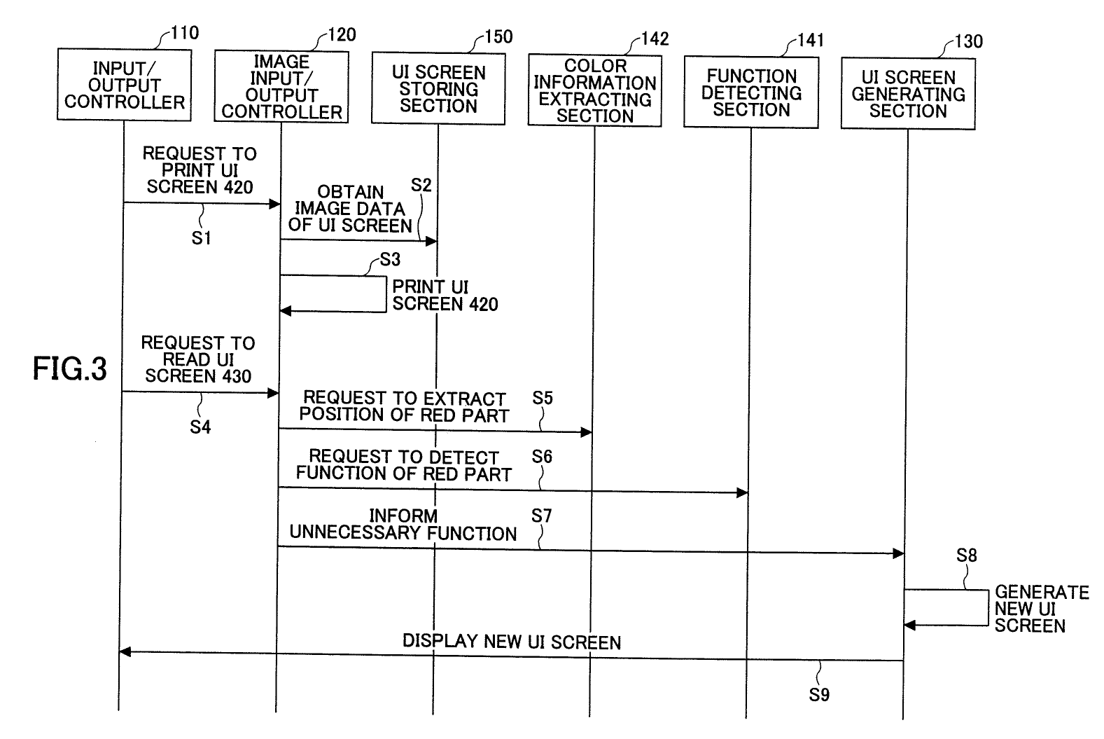

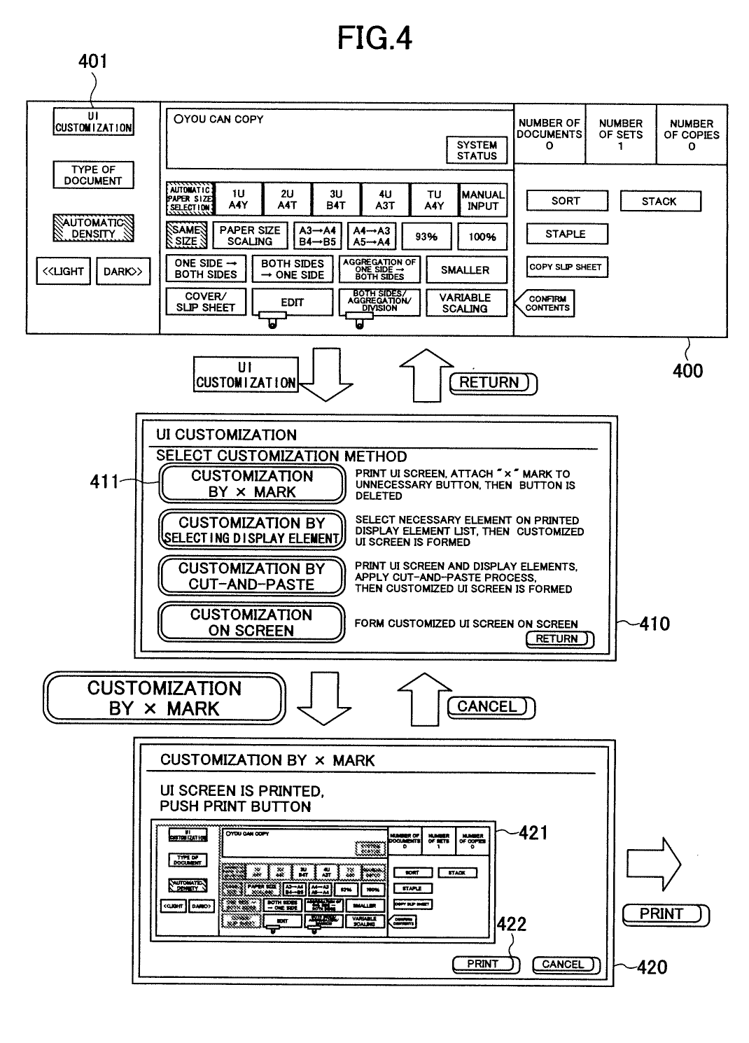

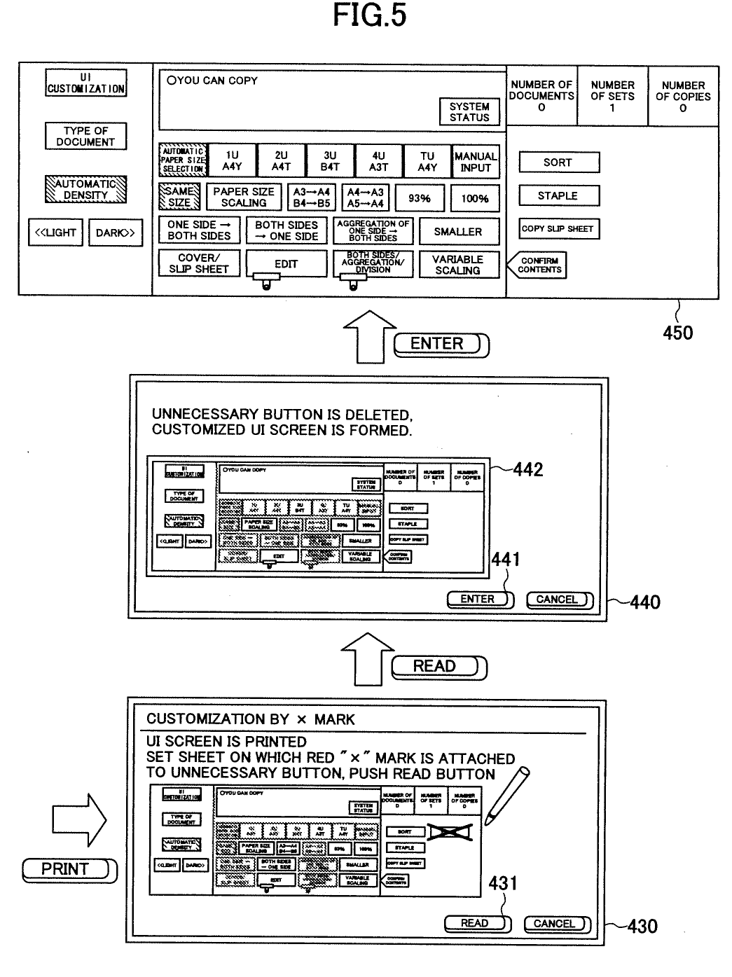

FIG. 3 is a sequence chart showing UI screen customizing processes in the MFP 1 according to the first embodiment of the present invention. FIG. 4 is a first diagram showing UI screens which are displayed on the operating panel 12 according to the first embodiment of the present invention. FIG. 5 is a second diagram showing UI screens which are displayed on the operating panel 12 according to the first embodiment of the present invention.

In FIGS. 4 and 5, only main elements are translated into English and others are in Japanese.

Referring to FIGS. 2 through 5, the UI screen customizing processes are described.

When a user desires to customize a UI screen 400 being displayed on the operating panel 12, the user pushes (touches) a UI customization button 401.

When the input/output controller 110 receives information of the push of the UI customization button 401 via the panel controller 13, the input/output controller 110 displays a UI screen 410 on the operating panel 12. When a user selects to customize the UI screen 400 by using, for example, customization by “x” mark, the user pushes (touches) a customization by “x” mark button 411 on the UI screen 410.

When the input/output controller 110 receives information of the push of the customization by “x” mark button 411 via the panel controller 13, the input/output controller 110 displays a UI screen 420 on the operating panel 12. The UI screen 420 includes an image 421 of the UI screen 400 to be customized. The user pushes (touches) a print button 422 on the UI screen 420.

When the input/output controller 110 receives information of the push of the print button 422 via the panel controller 13, the input/output controller 110 requests the image input/output controller 120 to print the UI screen 420 on a sheet (S1). The image input/output controller 120 obtains image data to print the UI screen 420 from the UI image storing section 150 (S2).

The image input/output controller 120 prints the UI screen 420 on a sheet by utilizing the engine controller 15 and the scanning/printing engine 14 based on the obtained image data (S3). After printing the UI screen 420, the input/output controller 110 displays a UI screen 430 on the operating panel 12.

On the UI screen 430, sentences “UI SCREEN IS PRINTED”, “SET SHEET ON WHICH RED “x” MARK IS ATTACHED TO UNNECESSARY BUTTON”, and “PUSH READ BUTTON” are displayed. The user attaches a red “x” mark to an unnecessary button on the printed UI screen 430. Then the user sets the printed sheet on which the red “x” mark is attached to the unnecessary button on a paper reading position of the MFP 1 and pushes a read button 431 on the UI screen 430. That is, the UI screen 430 is printed and displayed.

When the input/output controller 110 receives information of the push of the read button 431 via the panel controller 13, the input/output controller 110 requests the image input/output controller 120 to read the image on the printed UI screen 430 on which the red “x” mark is attached to the unnecessary button (S4). The image input/output controller 120 reads the image on the printed UI screen 430 by utilizing the engine controller 15 and the scanning/printing engine 14.

The image input/output controller 120 requests the color information extracting section 142 in the unnecessary function extracting section 140 to extract the position of the red part (where the red mark is attached) on the UI screen 430 (S5). The color information extracting section 142 extracts the position of the red part on the UI screen 430. Then the image input/output controller 120 requests the function detecting section 141 in the unnecessary function extracting section 140 to detect a function of the red part (S6). The function detecting section 141 detects an unnecessary function from the position of the red part of the UI screen 430 extracted by the color information extracting section 142.

The image input/output controller 120 informs the UI screen generating section 130 of the unnecessary function detected by the unnecessary function extracting section 140 (S7). The UI screen generating section 130 generates a new UI screen in which the unnecessary function is deleted from the UI screen 430 (S8). The UI screen generating section 130 requests the input/output controller 110 to display a UI screen 440 including a customized image 442 in which the unnecessary function is deleted (S9). The input/output controller 110 displays the UI screen 440 on the operating panel 12.

The user confirms the customized image 442 in the UI screen 440 displayed on the operating panel 12 and pushes an enter button 441 on the UI screen 440. The input/output controller 110 receives information of the push of the enter button 441 via the panel controller 13 and displays a new customized UI screen 450 on the operating panel 12.

As described above, according to the first embodiment of the present invention, a user attaches a red “x” mark to an unnecessary button on the printed UI screen 430, and the user instructs the reading of the printed UI screen 430 to which the red “x” mark is attached. With this, the customized UI screen 450 in which an unnecessary button is deleted can be obtained. Therefore, the user can easily customize the UI screen 400.

### Second Embodiment

Next, a second embodiment of the present invention is described.

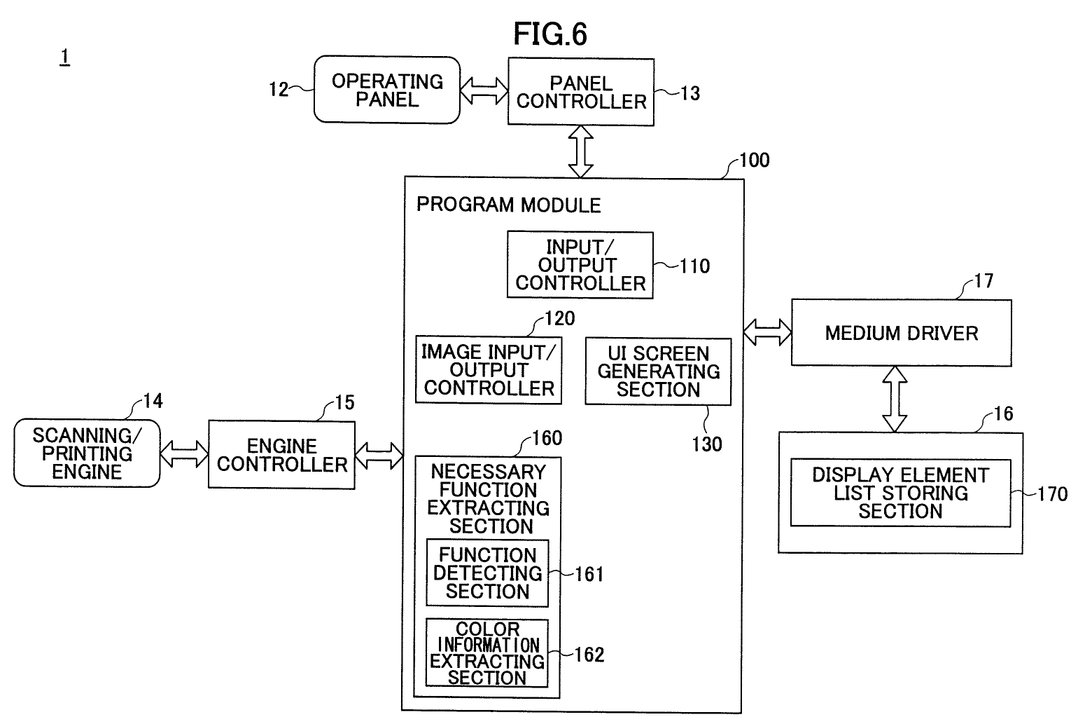

In the second embodiment of the present invention, a UI screen is customized by selecting a display element. FIG. 6 is a block diagram showing an MFP 1 according to a second embodiment of the present invention. In the MFP 1 of the present embodiment, a program module 100 is established by a UI screen customizing program. In the second embodiment of the present invention, the reference number of the MFP is the same as that of the MFP in the first embodiment of the present invention; however, the contents of the MFP are different from each other. In addition, in the second embodiment of the present invention, the reference number of the program module is the same as that of the program module in the first embodiment of the present invention; however, the contents of the program module are different from each other.

As shown in FIG. 6, the program module 100 includes an input/output controller 110, an image input/output controller 120, a UI screen generating section 130, and a necessary function extracting section 160. The necessary function extracting section 160 includes a function detecting section 161 and a color information extracting section 162. In addition, as shown in FIG. 6, the MFP 1 includes a display element list storing section 170. The display element list storing section 170 stores image data to print a display element list. In the MFP 1 shown in FIG. 6, only main elements to customize a UI screen are shown.

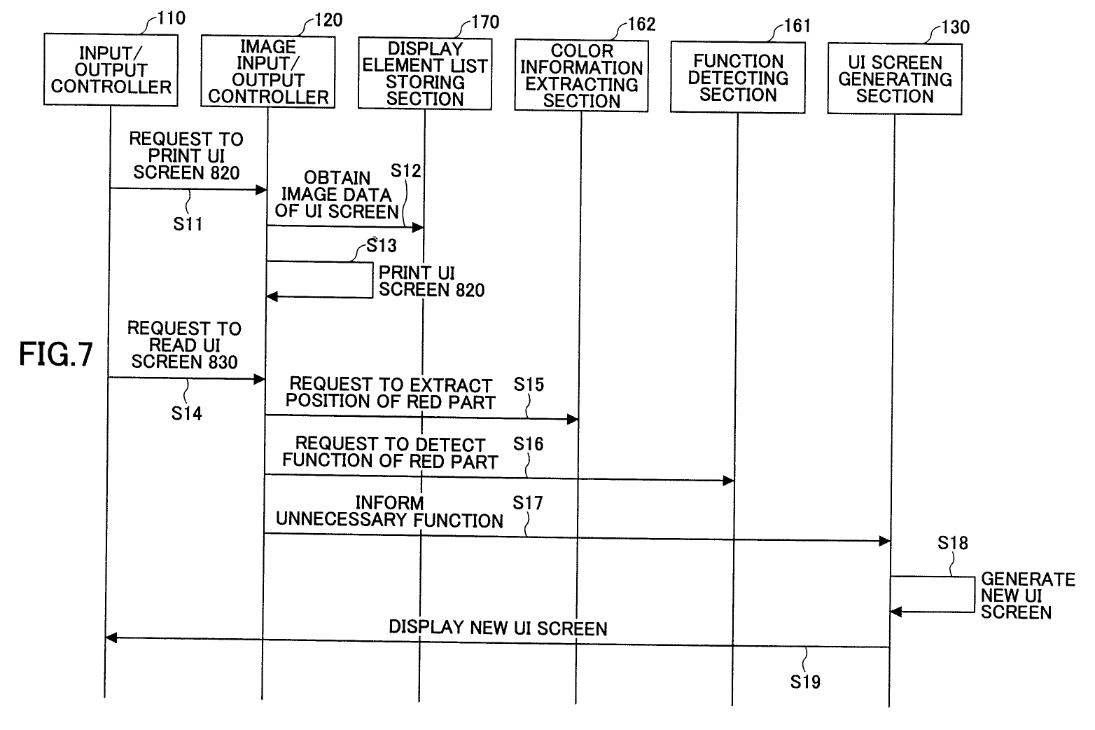

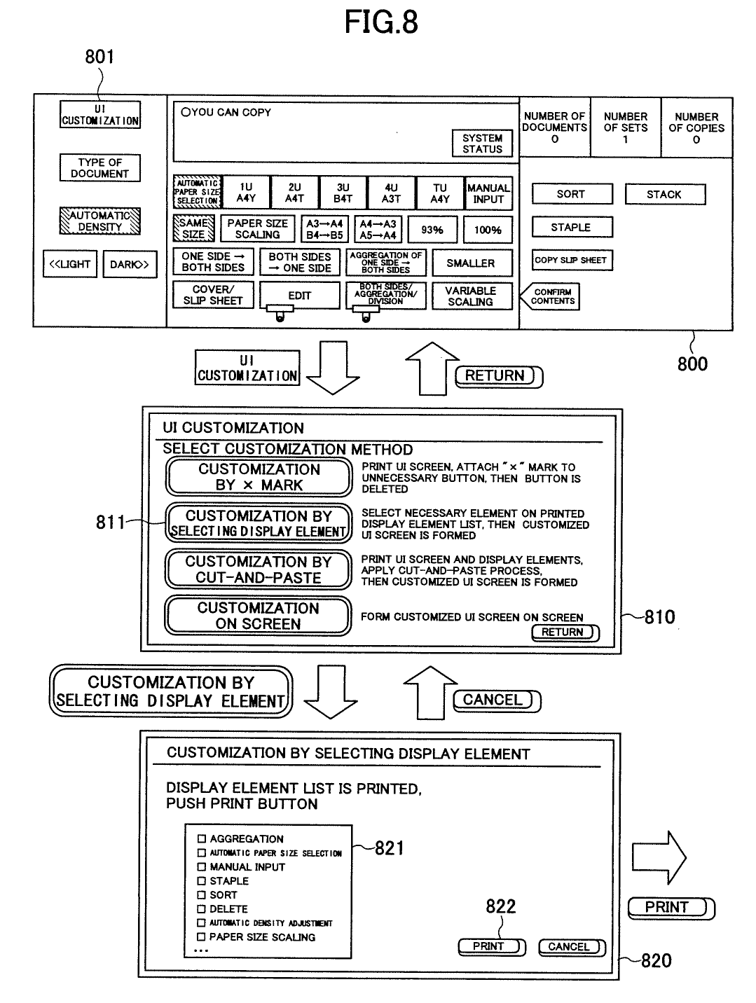

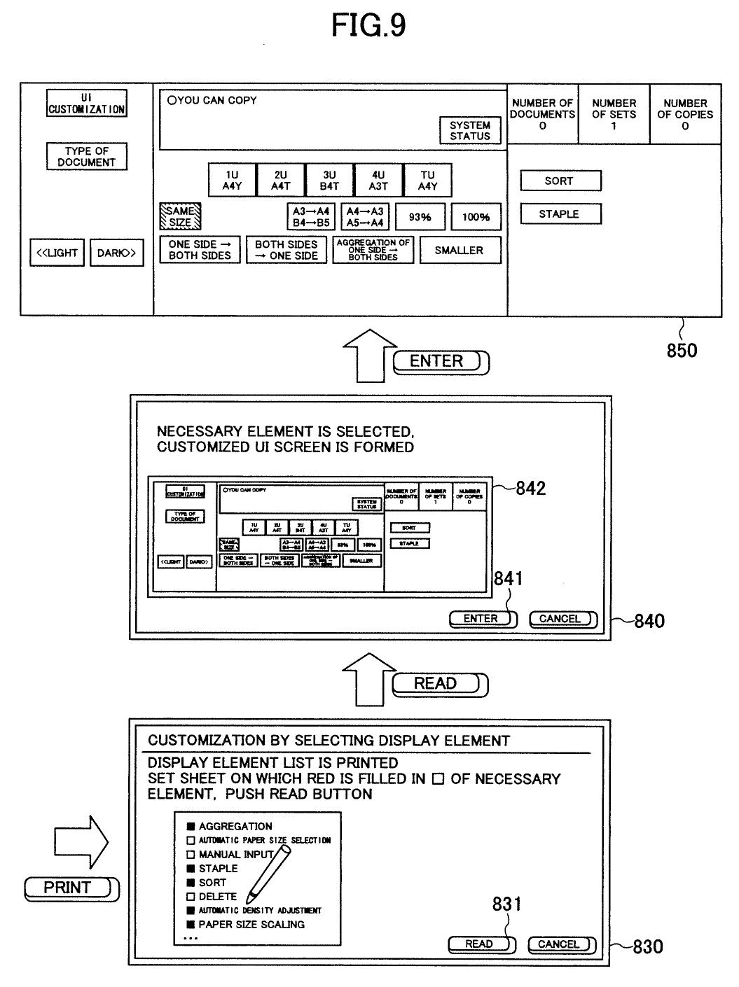

FIG. 7 is a sequence chart showing UI screen customizing processes in the MFP 1 according to the second embodiment of the present invention. FIG. 8 is a first diagram showing UI screens which are displayed on the operating panel 12 according to the second embodiment of the present invention. FIG. 9 is a second diagram showing UI screens which are displayed on the operating panel 12 according to the second embodiment of the present invention.

In FIGS. 8 and 9, only main elements are translated into English and others are in Japanese.

Referring to FIGS. 6 through 9, the UI screen customizing processes are described.

When a user desires to customize a UI screen 800 being displayed on the operating panel 12, the user pushes (touches) a UI customization button 801.

When the input/output controller 110 receives information of the push of the UI customization button 801 via the panel controller 13, the input/output controller 110 displays a UI screen 810 on the operating panel 12. When a user selects to customize the UI screen 800 by selecting a display element, the user pushes (touches) a button 811 (customization by selecting display element button 811) on the UI screen 810.

When the input/output controller 110 receives information of the push of the button 811 via the panel controller 13, the input/output controller 110 displays a UI screen 820 on the operating panel 12. The UI screen 820 includes a display element list 821. Then the user pushes (touches) a print button 822 on the UI screen 820.

When the input/output controller 110 receives information of the push of the print button 822 via the panel controller 13, the input/output controller 110 requests the image input/output controller 120 to print the UI screen 820 including the display element list 821 on a sheet (S11). The image input/output controller 120 obtains image data to print the UI screen 820 including the display element list 821 from the display element list storing section 170 (S12).

The image input/output controller 120 prints the UI screen 820 including the display element list 821 on a sheet by utilizing the engine controller 15 and the scanning/printing engine 14 based on the obtained image data (S13). After printing the UI screen 820 including the display element list 821, the input/output controller 110 displays a UI screen 830 on the operating panel 12.

In the UI screen 830, sentences “DISPLAY ELEMENT LIST IS PRINTED”, “SET SHEET ON WHICH RED IS FILLED IN □ OF NECESSARY ELEMENT”, and “PUSH READ BUTTON” are displayed. The user fills with red the □ of a necessary display element on the printed UI screen 830. Then the user sets the printed sheet on a paper reading position of the MFP 1 and pushes a read button 831 on the UI screen 830. That is, the UI screen 830 is printed and displayed.

When the input/output controller 110 receives information of the push of the read button 831 via the panel controller 13, the input/output controller 110 requests the image input/output controller 120 to read the image on the printed UI screen 830 (S14). The image input/output controller 120 reads the image on the printed UI screen 830 by utilizing the engine controller 15 and the scanning/printing engine 14.

The image input/output controller 120 requests the color information extracting section 162 in the necessary function extracting section 160 to extract the position of the red part on the UI screen 830 (S15). The color information extracting section 162 extracts the position of the red part on the display element list 821. Then the image input/output controller 120 requests the function detecting section 161 in the necessary function extracting section 160 to detect a function of the red part (S16). The function detecting section 161 detects a necessary function from the position of the red part of the display element list 821 extracted by the color information extracting section 162.

The image input/output controller 120 informs the UI screen generating section 130 of the necessary function detected by the necessary function extracting section 160 (S17). The UI screen generating section 130 generates a new UI screen in which the informed necessary functions are included (S18). The UI screen generating section 130 requests the input/output controller 110 to display a UI screen 840 including a customized image 842 in which the necessary functions are included (S19). The input/output controller 110 displays the UI screen 840 on the operating panel 12.

The user confirms the customized image 842 in the UI screen 840 displayed on the operating panel 12 and pushes an enter button 841 on the UI screen 840. The input/output controller 110 receives information of the push of the enter button 841 via the panel controller 13 and displays a new UI screen 850 on the operating panel 12.

As described above, according to the second embodiment of the present invention, a user fills with red the □ of a necessary display element in the display element list 821, and the user instructs reading the printed UI screen 830. With this, the customized UI screen 850 in which unnecessary buttons are included can be obtained. Therefore, the user can easily customize the UI screen 800.

### Third Embodiment

Next, a third embodiment of the present invention is described.

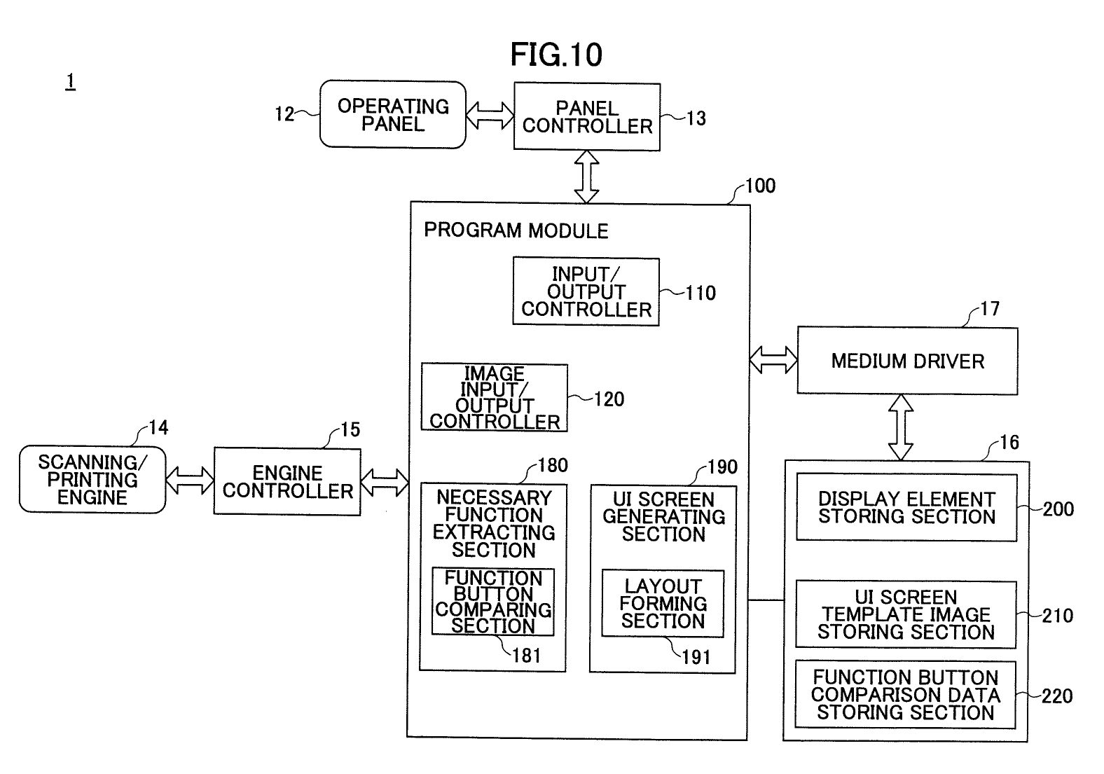

In the third embodiment of the present invention, a UI screen is customized by applying a cut-and-paste process to display elements. FIG. 10 is a block diagram showing an MFP 1 according to a third embodiment of the present invention. In the MFP 1 of the present embodiment, a program module 100 is established by a UI screen customizing program. In the third embodiment of the present invention, the reference number of the MFP is the same as that of the MFPs in the first and second embodiments of the present invention; however, the contents of the MFPs are different from each other. In addition, in the third embodiment of the present invention, the reference number of the program module is the same as that of the program modules in the first and second embodiments of the present invention; however, the contents of the program modules are different from each other.

As shown in FIG. 10, the program module 100 includes an input/output controller 110, an image input/output controller 120, a necessary function extracting section 180, and a UI screen generating section 190. The necessary function extracting section 180 includes a function button comparing section 181, and the UI screen generating section 190 includes a layout forming section 191. In addition, as shown in FIG. 10, the MFP 1 includes a display element storing section 200, a UI screen template image storing section 210, and a function button comparison data storing section 220.

The display element storing section 200 stores image data to print a display element. The UI screen template image storing section 210 stores image data to print a template of a UI screen. The function button comparison data storing section 220 stores image data to compare function buttons. In the MFP 1 shown in FIG. 10, only main elements to customize a UI screen are shown.

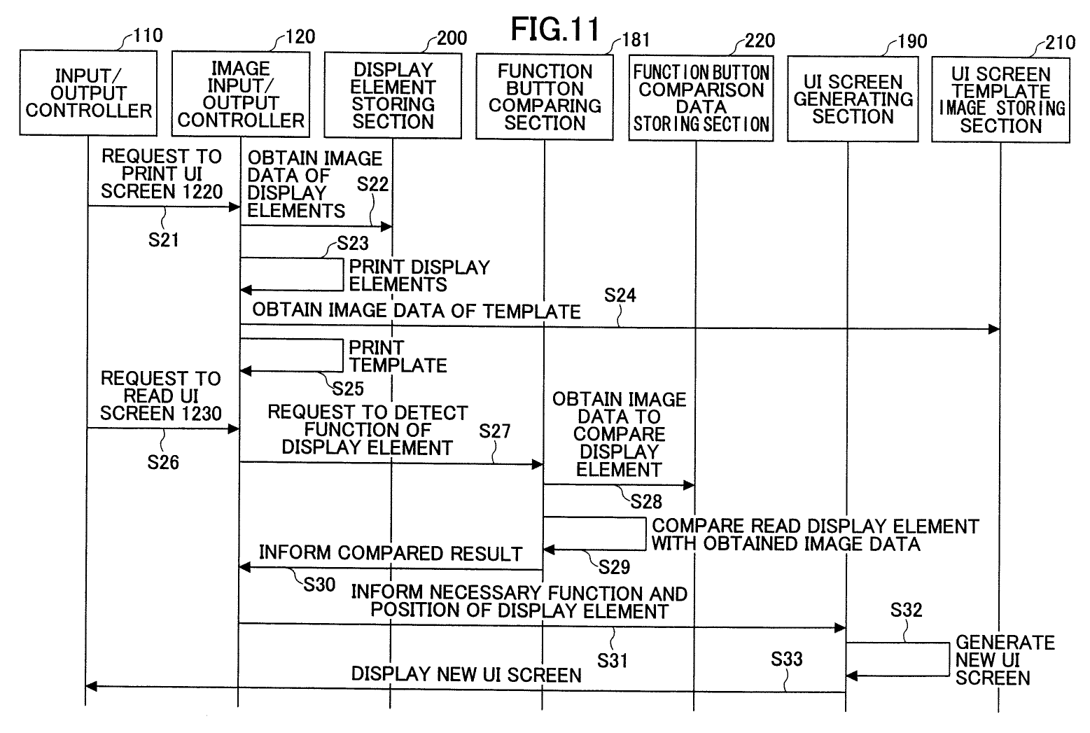

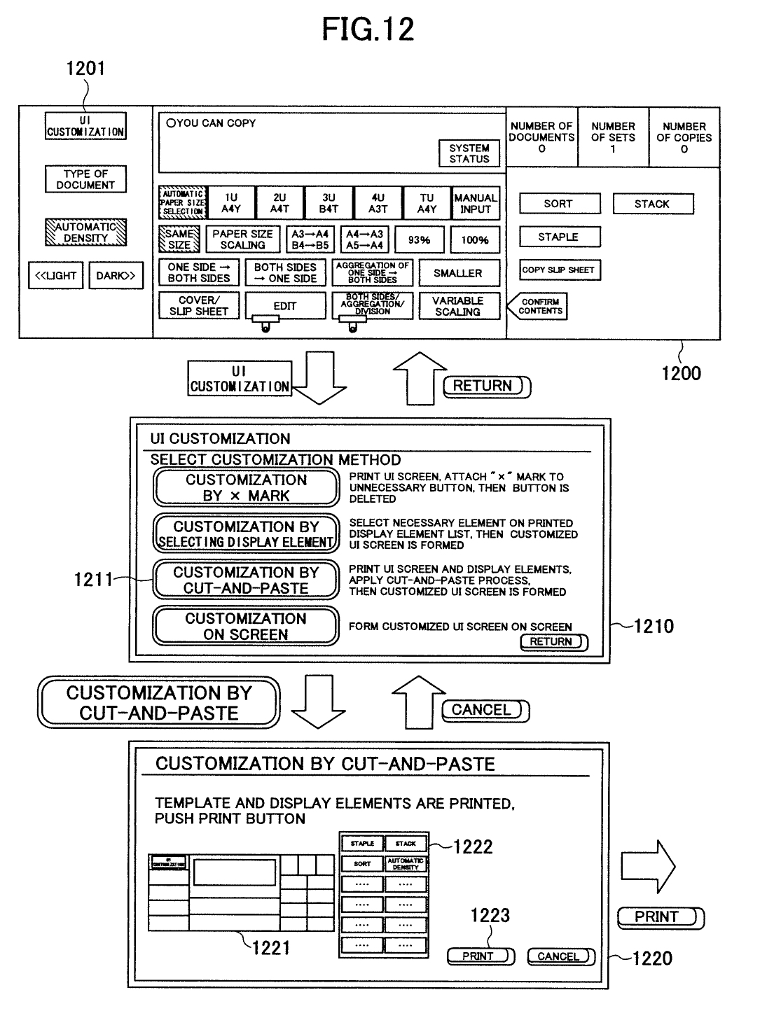

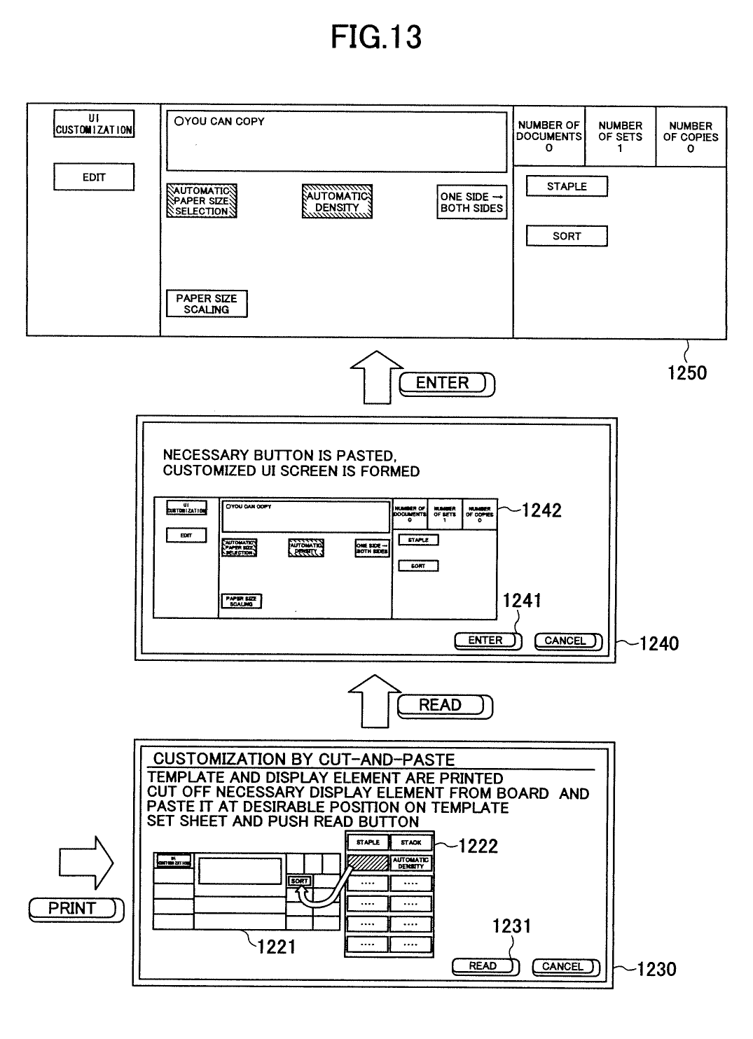

FIG. 11 is a sequence chart showing UI screen customizing processes in the MFP 1 according to the third embodiment of the present invention. FIG. 12 is a first diagram showing UI screens which are displayed on the operating panel 12 according to the third embodiment of the present invention. FIG. 13 is a second diagram showing UI screens which are displayed on the operating panel 12 according to the third embodiment of the present invention.

In FIGS. 12 and 13, only main elements are translated into English and others are in Japanese.

Referring to FIGS. 10 through 13, the UI screen customizing processes are described.

When a user desires to customize a UI screen 1200 being displayed on the operating panel 12, the user pushes (touches) a UI customization button 1201.

When the input/output controller 110 receives information of the push of the UI customization button 1201 via the panel controller 13, the input/output controller 110 displays a UI screen 1210 on the operating panel 12. When a user selects to customize the UI screen 1200 by applying a cut-and paste process to display elements, the user pushes (touches) a button 1211 (customization by cut-and-paste button) on the UI screen 1210.

When the input/output controller 110 receives information of the push of the button 1211 via the panel controller 13, the input/output controller 110 displays a UI screen 1220 on the operating panel 12. The UI screen 1220 includes a template 1221 and one or more display elements 1222. Then the user pushes (touches) a print button 1223 on the UI screen 1220.

When the input/output controller 110 receives information of the push of the print button 1223 via the panel controller 13, the input/output controller 110 requests the image input/output controller 120 to print the UI screen 1220 on a sheet (S21).

The image input/output controller 120 obtains image data to print the display elements 1222 from the display element storing section 200 (S22). The image input/output controller 120 prints the display elements 1222 on a sheet by utilizing the engine controller 15 and the scanning/printing engine 14 based on the obtained image data (S23). As the sheet for printing the display elements 1222, a sticker sheet can be used.

The image input/output controller 120 obtains image data to print the template 1221 from the UI screen template image storing section 210 (S24). The image input/output controller 120 prints the template 1221 on a sheet by utilizing the engine controller 15 and the scanning/printing engine 14 based on the obtained image data (S25).

After printing the display elements 1222 and the template 1221, the input/output controller 110 displays a UI screen 1230 on the operating panel 12.

On the UI screen 1230, sentences “TEMPLATE AND DISPLAY ELEMENTS ARE PRINTED”, “CUT OFF NECESSARY DISPLAY ELEMENT FROM BOARD AND PASTE IT AT DESIRABLE POSITION ON TEMPLATE”, and “SET SHEET AND PUSH READ BUTTON” are displayed.

The user cuts off a necessary display element 1222 from a board and pastes the necessary display element on a desirable position on the template 1221 printed on a sheet. Then the user sets the sheet (printed paper) on a paper reading position of the MFP 1 and pushes a read button 1231 on the UI screen 1230.

When the input/output controller 110 receives information of the push of the read button 1231 via the panel controller 13, the input/output controller 110 requests the image input/output controller 120 to read the image on the printed UI screen 1230 (S26). The image input/output controller 120 reads the image on the printed UI screen 1230 by utilizing the engine controller 15 and the scanning/printing engine 14.

The image input/output controller 120 requests the function button comparing section 181 in the necessary function extracting section 180 to detect a function of the display element 1222 (S27). The function button comparing section 181 obtains image data to compare the display element 1222 from the function button caparison data storing section 220 (S28). The function button comparing section 181 compares the display element 1222 read from the sheet with the function button comparison data.

The function button comparing section 181 detects the display element 1222 pasted on the template 1221 and a position where the display element 1222 is pasted based on the compared result. The function button comparing section 181 informs the image input/output controller 120 of the detected result (S30). The detected result includes a necessary function of the display element 1222 pasted on the template 1221 and the position where the display element 1222 is pasted on the template 1221.

The image input/output controller 120 informs the UI screen generating section 190 of the necessary function and the position of the display element informed from the function button comparing section 181 (S31).

The UI screen generating section 190 generates a new UI screen from the informed necessary function and the position of the necessary display element (S32). The UI screen generating section 190 requests the input/output controller 110 to display a UI screen 1240 including a customized image 1242 in which the necessary functions are included (S33). The input/output controller 110 displays the UI screen 1240 on the operating panel 12.

The user confirms the customized image 1242 in the UI screen 1240 displayed on the operating panel 12 and pushes an enter button 1241 on the UI screen 1240. The input/output controller 110 receives information of the push of the enter button 1241 via the panel controller 13 and displays the new UI screen 1250 on the operating panel 12.

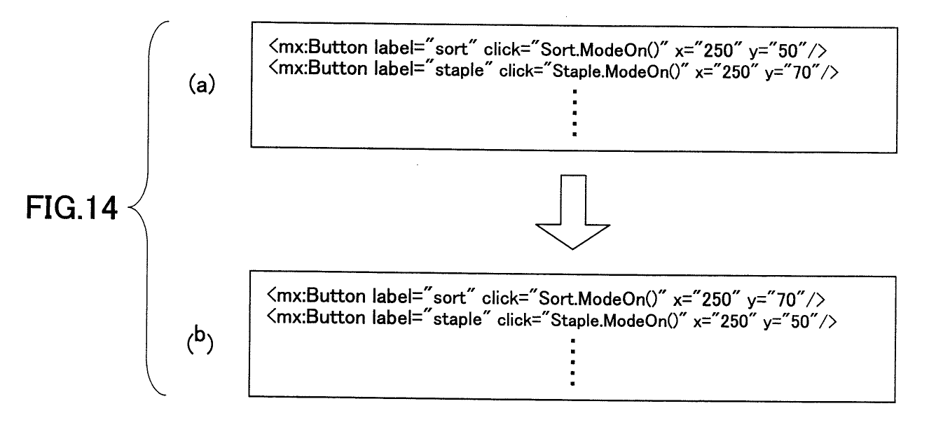

FIG. 14 is a diagram showing information to generate a new UI screen from a UI screen by customization. For example, information to generate a UI screen shown in FIG. 14(a) is changed to information to generate a new UI screen shown in FIG. 14(b). In (a) and (b) of FIG. 14, the position of a sort button and the position of a staple button are exchanged.

As described above, according to the third embodiment of the present invention, a user cuts off necessary display elements 1222 from a board and pastes the necessary display elements on desirable positions on a template 1221. Then the user makes the MFP 1 read the UI screen 1230. With this, the UI screen 1200 can be customized to the UI screen 1250. That is, the user can easily customize the UI screen 1200.

### Fourth Embodiment

Next, a fourth embodiment of the present invention is described.

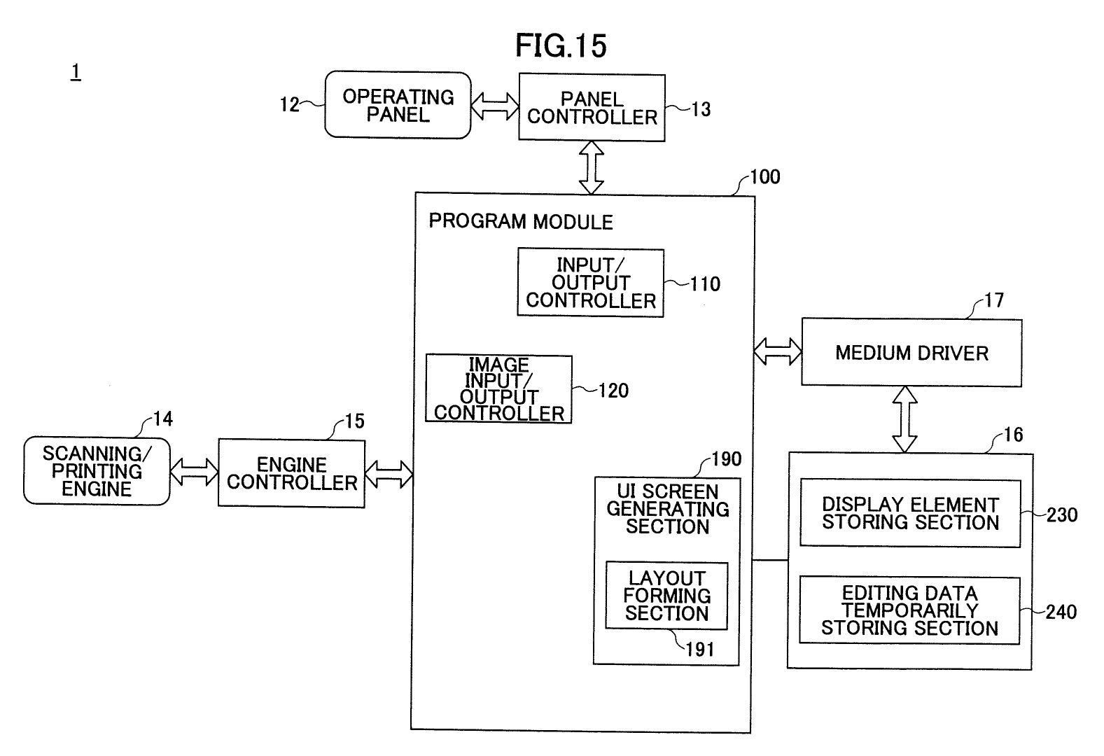

In the fourth embodiment of the present invention, a UI screen is customized on the UI screen. FIG. 15 is a block diagram showing an MFP 1 according to a fourth embodiment of the present invention. In the MFP 1 of the present embodiment, a program module 100 is established by a UI screen customizing program. In the fourth embodiment of the present invention, the reference number of the MFP is the same as that of the MFPs in the first through the third embodiments of the present invention; however, the contents of the MFPs are different from each other. In addition, in the fourth embodiment of the present invention, the reference number of the program module is the same as that of the program modules in the first through the third embodiments of the present invention; however, the contents of the program modules are different from each other.

As shown in FIG. 15, the program module 100 includes an input/output controller 110, an image input/output controller 120, and a UI screen generating section 190. The UI screen generating section 190 includes a layout forming section 191. In addition, as shown in FIG. 15, the MFP 1 includes a display element storing section 230, and an editing data temporarily storing section 240.

The display element storing section 200 stores image data to display a display element. The editing data temporarily storing section 240 stores data to execute an undo function and a redo function, and so on. In the MFP 1 shown in FIG. 15, only main elements to customize a UI screen are shown.

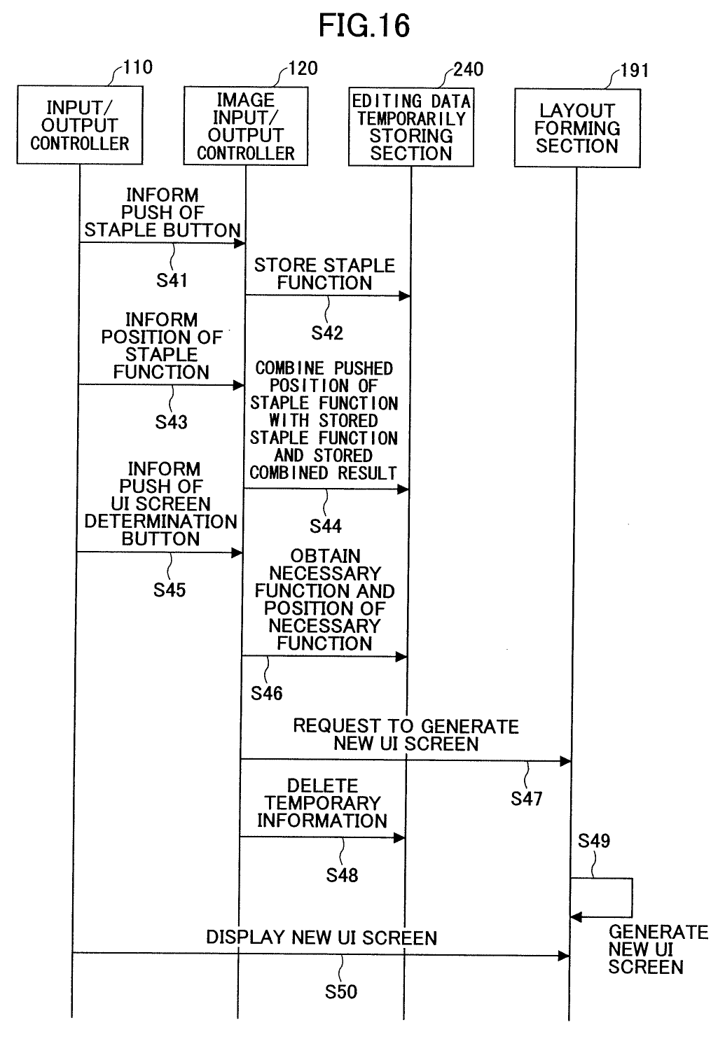

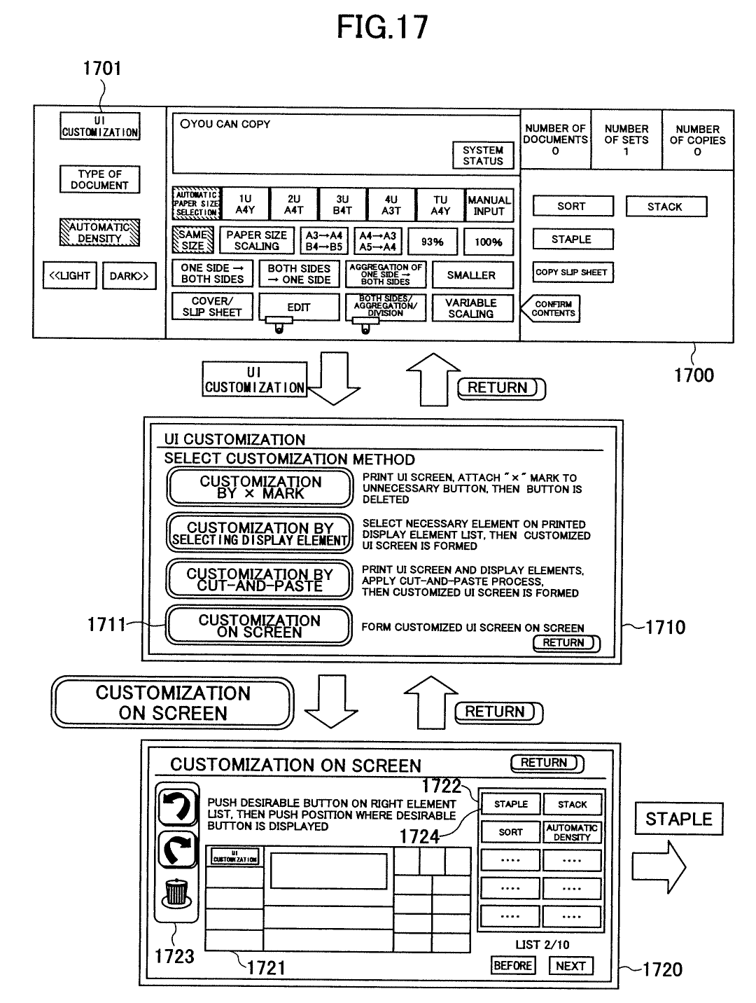

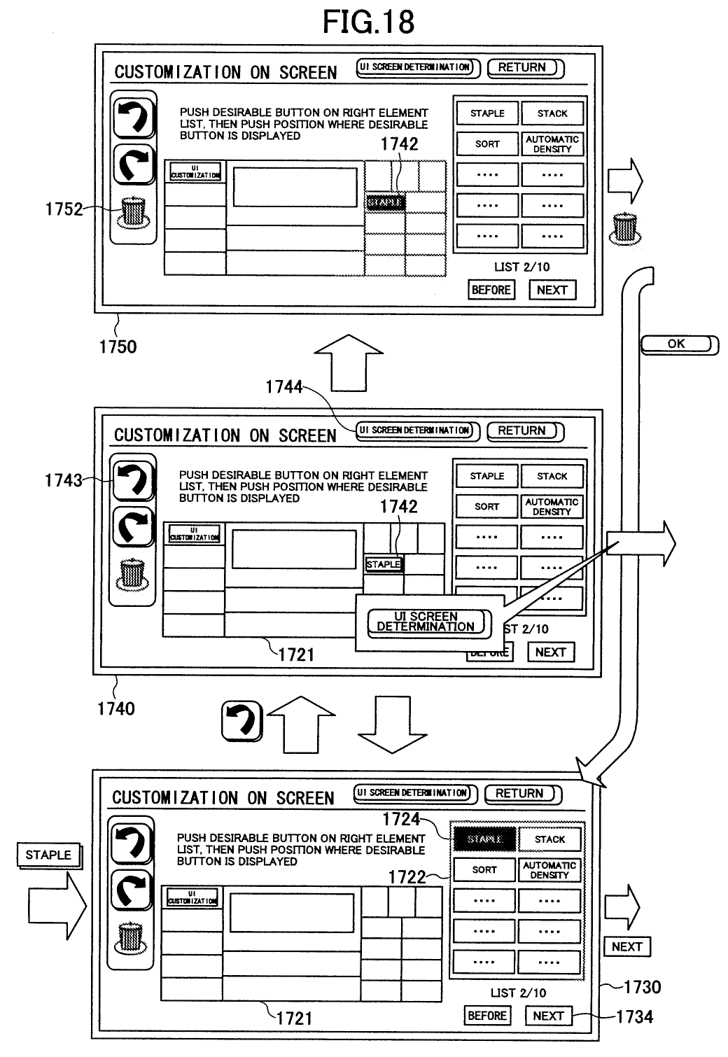

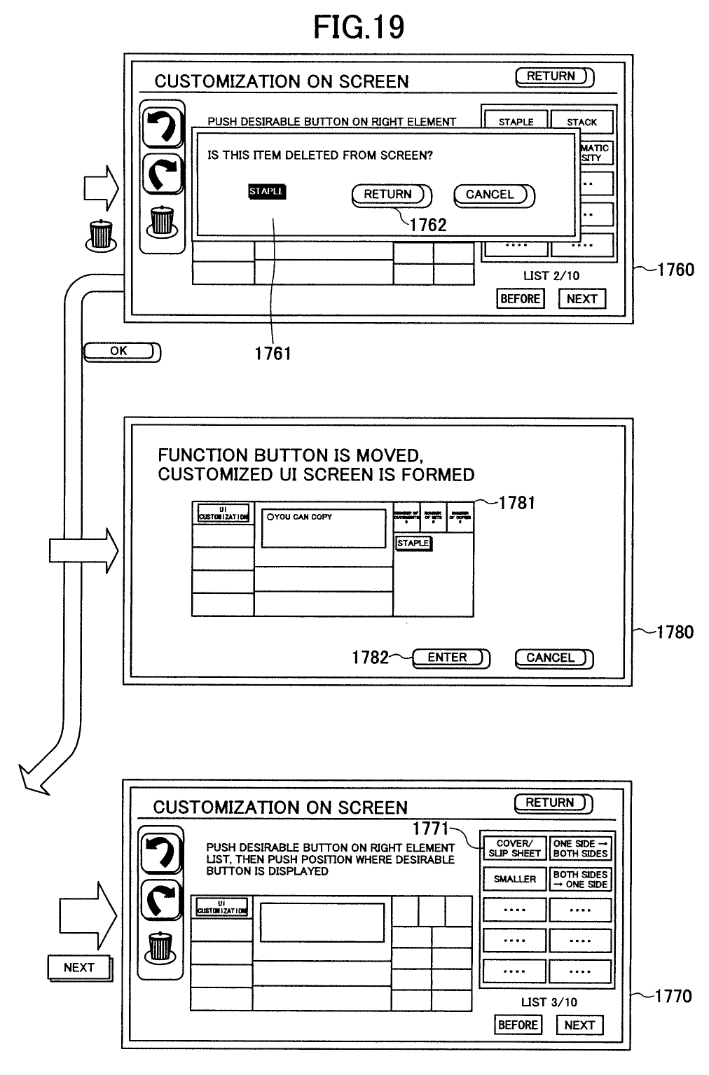

FIG. 16 is a sequence chart showing UI screen customizing processes in the MFP 1 according to the fourth embodiment of the present invention. FIG. 17 is a first diagram showing UI screens which are displayed on the operating panel 12 according to the fourth embodiment of the present invention. FIG. 18 is a second diagram showing UI screens which are displayed on the operating panel 12 according to the fourth embodiment of the present invention. FIG. 19 is a third diagram showing UI screens which are displayed on the operating panel 12 according to the fourth embodiment of the present invention.

In FIGS. 17 through 19, only main elements are translated into English and others are in Japanese.

Referring to FIGS. 15 through 19, the UI screen customizing processes are described.

When a user desires to customize a UI screen 1700 being displayed on the operating panel 12, the user pushes (touches) a UI customization button 1701.

When the input/output controller 110 receives information of the push of the UI customization button 1701 via the panel controller 13, the input/output controller 110 displays a UI screen 1710 on the operating panel 12. When the user desires to customize the UI screen 1700 on the UI screen 1700, the user pushes (touches) a button 1711 (customization on screen button) on the UI screen 1710.

When the input/output controller 110 receives information of the push of the button 1711 via the panel controller 13, the input/output controller 110 displays a UI screen 1720 on the operating panel 12. The UI screen 1720 includes a template 1721 of the UI screen 1700, one or more display elements 1722, and a function button 1723 in which one of an undo function button, a redo function button, and a delete function button is selected.

In this, the user pushes, for example, a staple button 1724 in the display elements 1722 on the UI screen 1720. When the input/output controller 110 receives information of the push of the staple button 1724 via the panel controller 13, the input/output controller 110 displays a UI screen 1730 on the operating panel 12. On the UI screen 1730, the staple button 1724 is highlighted.

The input/output controller 110 informs the image input/output controller 120 of the push of the staple button 1724 (S41). The image input/output controller 120 stores the staple function in the editing data temporarily storing section 240 (S42).

Next, the user pushes a position where the user desires to position the staple button 1724 on the template 1721. When the input/output controller 110 receives information of the push of the position on the template 1721, the input/output controller 110 displays a UI screen 1740 on the operating panel 12. On the UI screen 1740, a staple button 1742 is displayed at a position where the user pushes on the template 1721. The input/output controller 110 informs the image input/output controller 120 of the position where the staple button 1742 is positioned on the template 1721 (S43).

The image input/output controller 120 combines the staple function stored in the editing data temporarily storing section 240 with the position of the staple button 1742 on the template 1721 and stores the combined result in the editing data temporarily storing section 240 (S44).

The user pushes a UI screen determination button 1744 on the UI screen 1740. When the input/output controller 110 receives information of the push of the UI screen determination button 1744 via the panel controller 13, the input/output controller 110 informs the image input/output controller 120 of the push of the UI screen determination button 1744 (S45).

The image input/output controller 120 obtains a necessary function and the position of the necessary function from the editing data temporarily storing section 240 (S46). The image input/output controller 120 requests the layout forming section 191 to form a new UI screen (S47). The request includes the necessary function and the display position of the necessary function. Then the image input/output controller 120 deletes the obtained data from the editing data temporarily storing section 240 (S48).

The layout forming section 191 forms a new UI screen based on the necessary function and the display position of the necessary function (S49). The layout forming section 191 requests the input/output controller 110 to display a UI screen 1780 including a customized UI screen image 1781 (S50). The input/output controller 110 displays the UI screen 1780 on the operating panel 12.

The user confirms the UI screen 1780 including the UI screen image 1781 and pushes an enter button 1782. When the input/output controller 110 receives information of the push of the enter button 1782, the input/output controller 110 displays the new UI screen including the UI screen image 1781 on the operating panel 12.

In addition, on the UI screen 1740, when the user desires to delete the staple button 1742 on the template 1721, the user pushes the staple button 1742 on the template 1721.

When the input/output controller 110 receives information of the push of the staple button 1742, the input/output controller 110 displays a UI screen 1750 on the operating panel 12. On the UI screen 1750, the staple button 1751 is highlighted.

Next, the user pushes a delete button 1752 in the function button 1723 on the UI screen 1750. When the input/output controller 110 receives information of the push of the delete button 1752 in the function button 1723 via the panel controller 13, the input/output controller 110 displays a UI screen 1760 on the operating panel 12.

On the UI screen 1760, a dialog box 1761 is displayed on which box whether the staple button 1742 is deleted is displayed. When the user pushes a cancel button in the dialog box 1761, the input/output controller 110 again displays the UI screen 1730 on the operating panel 12.

In addition, when plural pages of display elements exist on the UI screen 1730, the user pushes a next button 1734 on the UI screen 1730. Then a UI screen 1770 having display elements 1771 of the next page is displayed on the operating panel 12.

In addition, when the user pushes an undo function button 1743 on the UI screen 1740, the previous UI screen 1730 can be displayed on the operating panel 12.

As described above, according to the fourth embodiment of the present invention, a user can dispose a display element on a desirable position on a UI screen. With this, a customized UI screen can be obtained on the UI screen. That is, the user can easily customize the UI screen 1700.

Further, the present invention is not limited to the specifically disclosed embodiments, and variations and modifications may be made without departing from the scope of the present invention.

The present invention is based on Japanese Priority Patent Application No. 2006-075642, filed on Mar. 17, 2006, with the Japanese Patent Office, the entire contents of which are hereby incorporated herein by reference.

What is claimed is:

1. An image processing apparatus capable of displaying a user interface screen (UI screen), comprising:
an input/output controlling unit to which customization information for customizing the UI screen is input by a user when the user inputs a customization request of the UI screen; and
a UI screen generating unit which generates a new UI screen based on the customization information.

2. The image processing apparatus as claimed in claim 1, further comprising:
an unnecessary function extracting unit which extracts an unnecessary function selected by the user from the customization information; wherein
the UI screen generating unit deletes the unnecessary function from the UI screen.

3. The image processing apparatus as claimed in claim 1, wherein:
the input/output controlling unit outputs a sheet on which a present UI screen is printed when the user inputs the customization request of the present UI screen, and reads the customization information printed on the sheet when the user inputs a reading request of the sheet.

4. The image processing apparatus as claimed in claim 3, wherein:
the customization information printed on the sheet is expressed by a color and a position of a display element on the UI screen printed on the sheet.

5. The image processing apparatus as claimed in claim 1, further comprising:
a necessary function extracting unit which extracts a necessary function selected by the user from the customization information; wherein
the UI screen generating unit generates a new UI screen on which the necessary function selected by the user is displayed.

6. The image processing apparatus as claimed in claim 5, wherein:
the input/output controlling unit outputs a sheet on which a display element list of the present UI screen is printed when the user inputs the customization request of the UI screen, and reads the customization information printed on the sheet when the user inputs a reading request of the sheet.

7. The image processing apparatus as claimed in claim 6, wherein:
the customization information printed on the sheet is expressed by a color and a position of a display element in the display element list on the UI screen printed on the sheet.

8. The image processing apparatus as claimed in claim 5, wherein:
the input/output controlling unit outputs a sheet on which display elements of the UI screen and a template on which the display element is to be pasted are printed when the user inputs the customization request of the UI screen, and reads the customization information printed on the sheet based on the display element pasted on the template of the UI screen when the user inputs a reading request of the sheet.

9. The image processing apparatus as claimed in claim 8, wherein:
the customization information printed on the sheet is expressed by a position of the display element pasted on the template on the UI screen printed on the sheet.

10. The image processing apparatus as claimed in claim 1, wherein:
the input/output controlling unit displays display elements of the UI screen and a template on which the display element is to be pasted on an operating panel when the user inputs the customization request of the UI screen, and reads the customization information displayed on the operating panel based on the display element pasted on the template of the UI screen when the user inputs a reading request of the customization information on the operating panel.

11. The image processing apparatus as claimed in claim 10, wherein:
the customization information displayed on the operating panel is expressed by a position of the display element pasted on the template on the UI screen displayed on the operating panel.

12. A customizing method of a user interface screen (UI screen) in an image processing apparatus capable of displaying the UI screen, comprising:
an input/output controlling step in which customization information for customizing the UI screen is input by a user when the user inputs a customization request of the UI screen; and
a UI screen generating step which generates a new UI screen based on the customization information.

13. The customization method of the UI screen as claimed in claim 12, further comprising:
an unnecessary function extracting step which extracts an unnecessary function selected by the user from the customization information; wherein
the UI screen generating unit deletes the unnecessary function from the UI screen.

14. The customization method of the UI screen as claimed in claim 12, wherein:
the input/output controlling step outputs a sheet on which a present UI screen is printed when the user inputs the customization request of the present UI screen, and reads the customization information printed on the sheet when the user inputs a reading request of the sheet.

15. The customization method of the UI screen as claimed in claim 14, wherein:
the customization information printed on the sheet is expressed by a color and a position of a display element on the UI screen printed on the sheet.

16. The customization method of the UI screen as claimed in claim 12, further comprising:
a necessary function extracting step which extracts a necessary function selected by the user from the customization information; wherein
the UI screen generating step generates a new UI screen on which the necessary function selected by the user is displayed.

17. The customization method of the UI screen as claimed in claim 12, wherein:
the input/output controlling step outputs a sheet on which a display element list of the present UI screen is printed when the user inputs the customization request of the UI screen, and reads the customization information printed on the sheet when the user inputs a reading request of the sheet.

18. The customization method of the UI screen as claimed in claim 12, wherein:
the input/output controlling step outputs a sheet on which display elements of the UI screen and a template on which the display element is to be pasted are printed when the user inputs the customization request of the UI screen, and reads the customization information printed on the sheet based on the display element pasted on the template of the UI screen when the user inputs a reading request of the sheet.

19. The customization method of the UI screen as claimed in claim 12, wherein:
the input/output controlling step displays display elements of the UI screen and a template on which the display element is to be pasted on an operating panel when the user inputs the customization request of the UI screen, and reads the customization information displayed on the operating panel based on the display element pasted on the template of the UI screen when the user inputs a reading request of the customization information on the operating panel.

20. A computer-readable recording medium storing a program for executing a customizing method of a user interface screen (UI screen) in an image processing apparatus capable of displaying the UI screen, wherein:
the program includes
an input/output controlling step in which customization information for customizing the UI screen is input by a user when the user inputs a customization request of the UI screen; and
a UI screen generating step which generates a new UI screen based on the customization information.
